(19) United States
(12) Patent Application Publication
(10) Pub. No.: US 2025/0371622 A1
(43) Pub. Date: Dec. 4, 2025

(54) Systems and Methods for Tracking and Assessing Collateral Utilization

(71) Applicant: The PNC Financial Services Group, Inc., Pittsburgh, VA (US)

(72) Inventor: Seth Garret JACOBSON, Moorhead, MN (US)

(21) Appl. No.: 19/203,394

(22) Filed: May 9, 2025

Related U.S. Application Data
(60) Provisional application No. 63/653,335, filed on May 30, 2024.

(51) Int. Cl. G06Q 40/06; G06Q 40/03

(52) U.S. Cl. CPC G06Q 40/06; G06Q 40/03

(57) ABSTRACT

Systems and methods are provided for a secured lending benefit analysis tool comprising one or more collateral databases and a processor. The one or more collateral databases include a valuation of a collateral portfolio of a user. The processor is coupled to the one or more collateral databases and is configured to simulate a first portfolio growth scenario based on liquidating a predetermined value of the collateral portfolio. The processor is further configured to simulate a second portfolio growth scenario based on obtaining a loan of the predetermined value. The loan is secured by collateral of the collateral portfolio. The processor is further configured to generate a portfolio growth simulation based on the first portfolio growth scenario and the second portfolio growth scenario. The processor is configured to display the portfolio growth simulation to the user.

### CROSS-REFERENCE TO RELATED APPLICATIONS

The present application claims priority to U.S. Provisional Application No. 63/653,335, filed May 30, 2024, which is incorporated herein by reference in its entirety.

### FIELD

This disclosure is related generally to secured financial networks and more particularly to monitoring collateral in a secured financial network.

### BACKGROUND

Financial institutions often monitor securities and other financial assets of thousands or even millions of users. Some of these assets may exist in different forms (e.g., stocks, real estate, bonds, etc.). Moreover, some assets of a single user may be present in different accounts. It may be critical to monitor and evaluate the assets to provide users with an accurate and reliable representation of their assets. For example, a user may base important financial decisions on a characterization of their assets. Moreover, some financial institutions may wish to monitor a user's assets to determine parameters of financial assistance (e.g., loans) to provide the user (e.g., based on the real time creditworthiness of the user).

Some methods of monitoring financial assets impose significant burdens on customer service systems. For example, a customer service system with limited infrastructure or personnel may have difficulty accommodating the specific financial needs of many users at the same time. Additionally, some customer service systems have difficulty simulating (e.g., projecting) growth scenarios of accounts of many customers. This difficulty may derive from, for example, a significant number of assets and parameters (e.g., complex financial derivatives, real estate or other less-liquid assets) associated with the differing assets, as well as uncertainty associated with those parameters. It may be advantageous to provide systems and methods that alleviate burdens on customer service systems.

### SUMMARY

Systems and methods are provided for a secured lending benefit analysis tool comprising one or more collateral databases and a processor. The one or more collateral databases include a valuation of a collateral portfolio of a user. The processor is coupled to the one or more collateral databases and is configured to simulate a first portfolio growth scenario based on liquidating a predetermined value of the collateral portfolio. The processor is further configured to simulate a second portfolio growth scenario based on obtaining a loan of the predetermined value. The loan is secured by collateral of the collateral portfolio. The processor is further configured to generate a portfolio growth simulation based on the first portfolio growth scenario and the second portfolio growth scenario. The processor is configured to display the portfolio growth simulation to the user.

As another example, a computer network comprises one or more collateral databases including a plurality of collateral portfolios for a plurality of users. The computer network further comprises a secured lending benefit analysis tool having access to the one or more collateral databases. The secured lending benefit analysis tool is configured to receive a user input from a machine being accessed by one of the plurality of users. Based on the user input, the secured lending benefit analysis tool simulates a first portfolio growth scenario based on liquidating a predetermined value of one of the collateral portfolios. Based on the user input, the secured lending benefit analysis tool simulates a second portfolio growth scenario based on obtaining a loan of the predetermined value. The loan is secured by collateral of the collateral portfolio. The secured lending benefit analysis tool generates a portfolio growth simulation based on the first portfolio growth scenario and the second portfolio growth scenario. The secured lending benefit analysis tool displays the portfolio growth simulation on the machine.

As a further example, a method of determining a portfolio growth simulation comprises valuating a collateral portfolio of a user. A first portfolio growth scenario is simulated based on liquidating a predetermined value of the collateral portfolio. A second portfolio growth scenario is simulated based on obtaining a loan of the predetermined value. The loan is secured by collateral of the collateral portfolio. A portfolio growth simulation is generated based on the first portfolio growth scenario and the second portfolio growth scenario. The portfolio growth simulation is displayed to the user.

### DESCRIPTION OF DRAWINGS

FIG. 1 is a diagram depicting a secured lending benefit analysis tool, in accordance with some embodiments.

FIG. 2 is a diagram depicting a financial network, in accordance with some embodiments.

FIG. 3 is a diagram depicting a system for monitoring collateral, in accordance with some embodiments.

FIG. 4 is a diagram depicting a system for monitoring collateral, in accordance with some embodiments.

FIG. 5 is a diagram depicting a depleted collateral simulation, in accordance with some embodiments.

FIG. 6 is a diagram depicting a secured loan simulation, in accordance with some embodiments.

FIG. 7 is a diagram depicting a benefit of borrowing simulation, in accordance with some embodiments.

FIG. 8 is a diagram depicting a portfolio growth simulation, in accordance with some embodiments.

FIG. 9 is a diagram depicting a method of determining a portfolio growth simulation, in accordance with some embodiments.

### DETAILED DESCRIPTION

As described above, some financial systems and networks experience significant burdens based on accommodating and monitoring assets of many users. In some examples, institutions may wish to effectively and accurately monitor assets of each user accessing its systems. For example, users may wish to simulate growth scenarios based on different allocations of their assets. Such simulations may further burden financial systems due to the inclusion of various accounts from a variety of platforms. Institutions may be further inclined to provide an accurate monitoring of assets based on potentially using those assets as collateral within a secured loan provided by the institution.

Systems and methods are provided for a secured lending benefit analysis tool that can reduce burdens on existing infrastructure and customer service systems. Systems and methods disclosed herein include a collateral database that includes portfolios comprising assets of a plurality of users. One or more portfolio growth scenarios may be generated based on a collateral portfolio and various potential approaches to allocating and/or investing those assets. The portfolio growth scenarios may be generated automatically or at the request of a user. Actions are then taken based on the analysis, whereby real-world impact (e.g., payment made to an entity, with an infrastructure improvement made based on that payment) is realized via the system's analysis. Systems and methods disclosed herein can thus reduce burdens on some existing infrastructure and customer service systems.

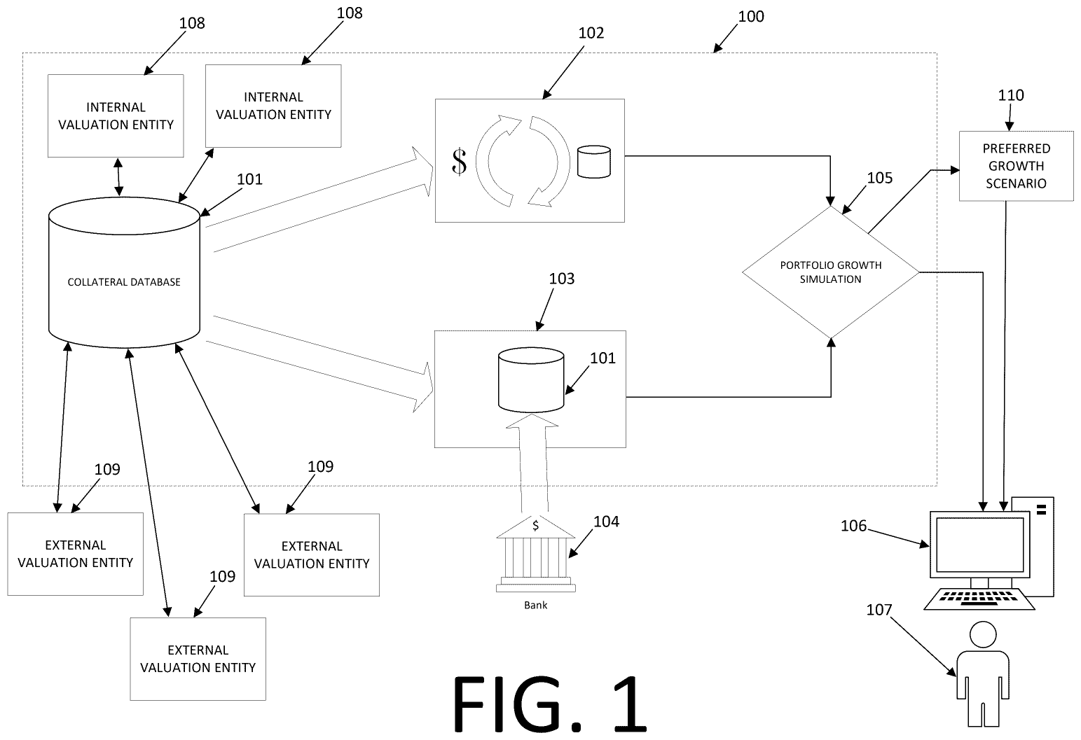

FIG. 1 is a diagram depicting a secured lending benefit analysis tool, in accordance with some embodiments. In the example shown in FIG. 1, the secured lending benefit analysis tool 100 includes a collateral database 101. The collateral database 101 may be, for example, a data store within a computer network. The collateral database includes a plurality of portfolios of one or more users 107. Each of the plurality of portfolios includes assets (e.g., collateral) of a user 107 with which the portfolio is associated. Furthermore, each portfolio may aggregate assets of the user across one or more accounts of different platforms. For example, a user may have a variety of assets, such as a real estate asset that is included in a real estate account and a stock portfolio included within a separate investment account.

In one embodiment, a system seeks to provide information to a user regarding different mechanisms for obtaining funds (e.g., funds for operating a business, funds for a capital expenditure). Those different mechanisms may take a variety of forms. In one example, the user could liquidate a portion of their existing portfolio assets to fund a project. In another example, the user could obtain the funds via a secured loan, where funds are provided to the user at an interest rate that is lower than for an unsecured loan with the user's assets being pledged as collateral. Each of these mechanisms has pros and cons. Liquidation of assets provides funds without ongoing repayment obligations. While this saves interest payments over time, the liquidated assets are no longer providing returns to the user's portfolio, which may somewhat or completely offset the benefit of the liquidation over the secured loan option. Furthermore, liquidating assets within the portfolio can have significant tax implications, which can impose financial burdens on the user. In different collateral situations and market conditions, different mechanisms may provide a user better short or long term results.

In the example shown in FIG. 1, the collateral database 101 is coupled to one or more internal valuation entities 108 (i.e., valuation entities within the same network as the lending benefit analysis tool 100) and one or more external valuation entities 109 (i.e., valuation entities outside of the network of the lending benefit analysis tool 100). In some examples, a third party vendor (e.g., Broadridge) can access the internal and external valuation entities 108, 109 or receive information from the valuation entities 108, 109 indirectly (e.g., through a financial institution). Moreover, the vendor may apply monitoring technology (e.g., FASTNET) to extract information from the internal and external valuation entities 108, 109. The monitoring of the valuation entities 108, 109 can be effectuated by secured accounts and may be based on product codes of the assets. Based on the information, the value of assets within the valuation entities can be determined. While FIG. 1 depicts the collateral database 101 coupled to the internal valuation entities 108 and the external valuation entities 109, in some examples the information derived from these entities 108, 109 and/or valuations made based on that information is performed by the vendor and provided to the collateral database 101.

The internal valuation entities 108 communicate to the collateral database 101 information regarding assets associated with the user 107. For example, the internal valuation entities 108 may be an account within the network and may communicate to the collateral database valuations of stocks and bonds held within the account, as well as parameters associated with those securities (e.g., volatility parameters (beta), volume information, price-to-earnings (PE) ratios, etc.).

The external valuation entities 109 communicate to the collateral database 101 information regarding assets of the user 107 that are external to the network of the lending benefit analysis tool 100. As an example, the collateral database 101 can extract from one of the external valuation entities 109 to determine whether the user 107 currently owns a particular asset (e.g., access a county real estate ledger to confirm the user 107 still owns a parcel of property). If the collateral database 101 confirms that the user 107 currently owns the asset, the collateral database 101 can then access a separate external valuation entity 109 to approximate a value of that asset. Moreover, in some examples the collateral database 101 may access a data platform (e.g., Adobe AEM Forms Service (AFS), National Financial (NFS) and AM Trust (TRS)) and determine valuations of assets within the collateral database 101 based on information within the data platform.

Furthermore, the collateral database 101 or the internal or external valuation entities 108, 109 may access a collateral monitoring solution (e.g., FASTNET) to determine current market values of assets based on the composition of the user portfolios within the collateral database 101. For example, the collateral database 101 may access a real estate valuation platform (e.g., Zillow) to determine a value of the real estate parcel. This can be done by determining valuation estimates and forward projections of similar real estate assets or by providing an address of the parcel and determining the valuation from the platform. Additionally, valuations of the assets within the collateral database 101 may be performed in real time (e.g., as the user accesses the collateral database 101) or at predetermined time intervals.

For example, some assets, such as bonds, equities, real estate, commodities, and cryptocurrencies may fluctuate frequently in accordance with asset's respective market. Assets within the collateral database 101 may thus be evaluated in real time, each minute, hourly, daily, or at any other predetermined time interval. The valuation of the assets may be based on, for example, a Credit Default Swap (CDS) pricing system. In some examples, the external valuation entities 109 are accounts from external financial institutions and include valuations of financial securities within those accounts.

The internal valuation entities 108 and external valuation entities 109 can further communicate to the collateral database 101 other information, such as capital of the user 107 held in a savings account (e.g., money market account (MMA)), and interest rates associated with the account. The internal and external valuation entities 108, 109 can also provide information regarding which, if any, assets within the valuation entities 108, 109 serve as collateral to an existing security interest, which creditors hold those security interests, and the priority of the security interests if more than one exists. Additionally, in some examples the valuation entities 108, 109 provide to the collateral database 101 information concerning past or recurring transactions with other entities. For example, the valuation entities 101 may receive recurring direct deposits from the user's 107 employer. The valuation entity 108, 109 can communicate an amount and frequency of these payments to the collateral database 101.

Valuations of assets within the user portfolios included in the collateral portfolio 101 are made based on the information the collateral database 101 receives from the internal valuation entities 108 and the external valuation entities 109. For example, the collateral database 101 can aggregate valuations of assets included within the user portfolio within the collateral database with valuations of assets included in the internal and external valuation entities 108, 109. In some examples, the valuation of the user's 107 assets accounts for uncertainties (e.g., estimates of market values of investment assets such as equities, fixed income, and cash equivalents) in valuations provided by the internal and external valuation entities 108, 109. These uncertainties can be reflected in, for example, the valuation of the user portfolio or by providing a determined range of the valuation (e.g., via confidence intervals). The collateral database 101 may further characterize the assets as being one or more predefined categories (e.g., securities, cash, inventory, letter of credit rights).

In an example, a first portfolio growth scenario 102 is applied to one or more of the user portfolios within the collateral database 101. The first portfolio growth scenario 102 is applied to the one or more portfolios based on a determined (e.g., calculated) value of the assets within the portfolios. The value of assets within the portfolio may be calculated based on information within the computer network that includes the secured lending benefit analysis tool, including within the collateral database 101. For example, information provided to the collateral database 101 by the internal and external valuation entities 108, 109 can be used to determine a total valuation of assets within the user portfolio. As described above, this information can be provided directly or via a third party vendor (e.g., Broadridge). Furthermore, information within the computer network or within the collateral database may be utilized to determine a liquidity level of each of the various forms of collateral.

The first portfolio growth scenario 102 may involve simulating a depletion (e.g., liquidation) of a predetermined portion of assets within the one or more portfolios. The simulation of the depletion may be based on the liquidity of assets determined by the collateral database 101 or the computer network. In an example, only assets having a liquidity level above a predetermined level are considered eligible for depletion for purposes of the first portfolio growth scenario 102. Moreover, in some examples a determination is made as to which assets are most preferable to a user to liquidate. Such a determination may be based on particular parameters. For example, it may be advantageous to the user 107 to liquidate assets having a lower rate of return than other assets, or to liquidate assets having a lower level of uncertainty (i.e., volatility) than other assets. Weights can be assigned to the parameters based on the importance of the respective parameter to the determination of whether that asset should be liquidated. The weights can be assigned to the parameter, for example, automatically based on user behavior or can be manually assigned to the parameter based on a user input. For example, a user may indicate that the rate or return of an asset is a relatively important parameter (e.g., a weight value of 0.8), while the volatility of an asset is a relatively unimportant parameter (e.g., a weight value of 0.2). The weights can be based on features of the user 107, such as stated goals and risk levels for their portfolio.

The assets within the portfolio are depleted, for example, to fund a venture of the user 107 or to purchase different assets. The assets may be depleted in exchange for a specified currency (e.g., U.S. dollar, cryptocurrency), security, promissory note, or other asset. The first portfolio growth scenario 102 represents a value of the portfolio over a course of a predetermined time period (e.g., 1, 5, 10, or 20 years) based on the depletion of collateral. The first portfolio growth scenario 102 may further provide valuations of the portfolio at one or more time intervals within the predetermined time period.

A second portfolio growth scenario 103 is applied to one or more of the portfolios within the collateral database 101. The second portfolio growth scenario 103 is applied to the same portfolios to which the first portfolio growth scenario 102 is applied. The second portfolio growth scenario 103 includes obtaining a secured loan from a financial institution (e.g., bank) 104. The assets within the portfolio operate as collateral within the secured loan from the bank 104. The secured loan may include a principal amount that is the same or similar to the value of the collateral that is depleted in the first portfolio growth scenario 102. The second portfolio growth scenario 103 represents a value of the portfolio over a course of the predetermined time period based on obtaining the secured loan from the financial institution. The second portfolio growth scenario 103 may further provide valuations of the portfolio at one or more time intervals within the predetermined time period.

The first portfolio growth scenario 102 and the second portfolio growth scenario 103 may be applied at the same time or at different times. The first and second portfolio growth scenarios 102, 103 may be in the form of a two-dimensional (2D) or three-dimensional (3D) model and can include interactive user feedback (e.g., displaying particular parameters or values of the growth scenarios at specified time points in the future based on a user selecting a particular point on the growth scenario).

Furthermore, in some examples, the first and second portfolio growth scenarios 102, 103 are generated automatically. For example, the secured lending benefit analysis tool 100 may detect that a user is considering depleting all or a portion of their portfolio within the collateral database 101 and may provide the first and second portfolio growth scenario 102, 103 in response to that consideration. Moreover, in some examples the secured lending benefit analysis tool 100 may generate the first and second portfolio growth scenarios 102, 103 based on a user input (e.g., button press).

The secured lending benefit analysis tool 100 may generate a portfolio growth simulation 105 based on the first portfolio growth scenario 102 and the second portfolio growth scenario 103. For example, the portfolio growth simulation 105 may combine information from both of the portfolio growth scenarios 102, 103 such that the different scenarios 102, 103 can be compared to each other and evaluated based on common parameters. Furthermore, the secured lending benefit analysis may in some instances identify a preferred growth scenario 110 out of the first portfolio growth scenario 102 and the second portfolio growth scenario 103. The preferred growth scenario 110 may be determined, for example, based on one or more parameters of the first portfolio growth scenario 102 and the second portfolio growth scenario 103. For example, the portfolio growth scenario 102, 103 with a greatest value after the predetermined time period may be the preferred growth scenario 110. Moreover, the portfolio growth scenario 102, 103 which results in a greater net worth of the user 107 may be the preferred growth scenario 110.

The portfolio growth simulation 105 is then displayed on a machine 106 of the user 107. The machine 106 may be a physical or virtual computer, a smart watch, a smartphone, or any other device. Additionally, each of the first portfolio growth scenario 102 and the second portfolio growth scenario 103 may be displayed to the user 107. In some examples, the portfolio growth simulation 105 includes the first and second portfolio growth scenarios 102, 103 overlayed or superimposed on each other. Furthermore, the preferred growth scenario 110 may be displayed within a browser window or web application of the machine 106.

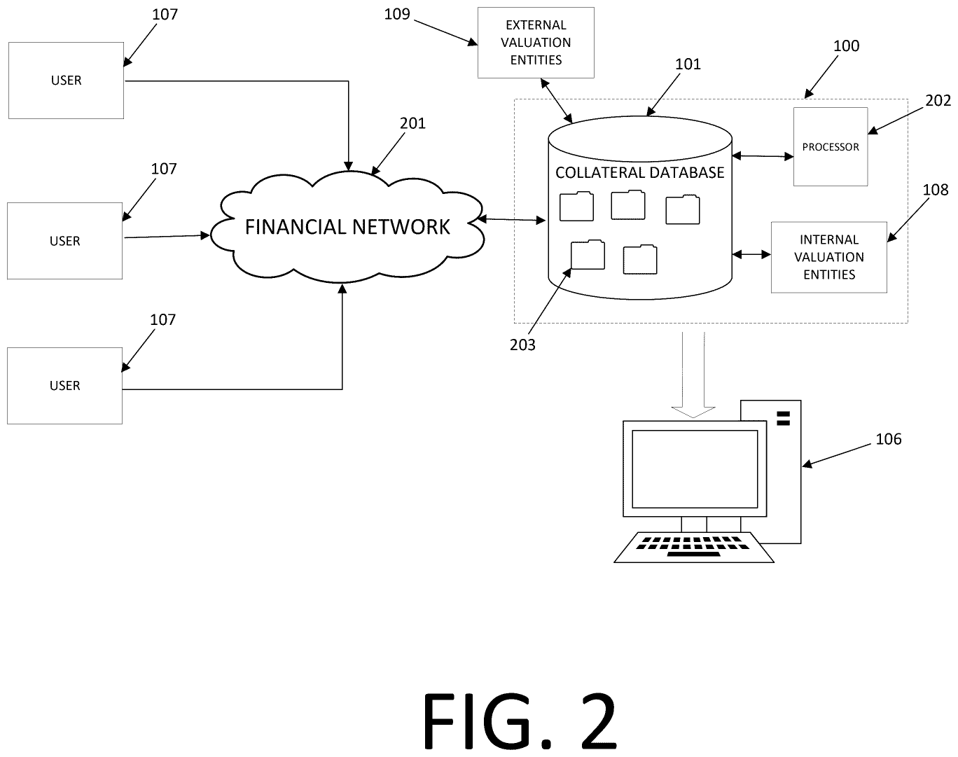

FIG. 2 is a diagram depicting a financial network, in accordance with some embodiments. As shown in FIG. 2, the financial network 201 facilitates connections between a plurality of users 107. The financial network 201 further includes the secured lending benefit analysis tool 100. The secured lending benefit analysis tool 100 includes the collateral database 101 and a processor 202 coupled to the collateral database 101. The collateral database 101 includes a plurality of portfolios 203. The users 107 have access to one or more portfolios 203 within the collateral database 101.

In some examples, the collateral database 101 is further coupled to the one or more internal valuation entities 108 and the one or more external valuation entities 109. As described above, the collateral database may include thousands or even millions of user portfolios 203. Furthermore, the collateral database 101 may in some cases execute multiple data extractions from the internal and external valuation entities 108, 109 for a single user portfolio 203 to valuate various assets of each user 107. Moreover, in some examples the collateral database 101 prompts a third party to obtain data concerning the value of the user's 107 assets, adding an additional layer of complexity. These numerous data extractions for each of the many user portfolio 203 within the collateral database 101 can require significant processing power and complex calculations.

The processor 202 is configured to process the valuation data obtained from the internal and external valuation entities 108, 109 and to simulate the first portfolio growth scenario 102, the second portfolio growth scenario 103, and the portfolio growth simulation 105 (FIG. 1). These functions may include the processes and functions described above with respect to FIG. 1. The machine 106 is coupled to the secured lending benefit analysis tool 100 through, for example, the financial network 101. The processor is configured to facilitate the display of the portfolio growth simulation 105, the first portfolio growth scenario 102, or the second portfolio growth scenario 103 on the machine 106. Because each of the users 107 may have one or more of the machines 106, thousands or millions of first portfolio growth scenarios 102, second portfolio growth scenarios 103, and portfolio growth simulations 105 may be generated. As described above, one or more of the users 107 may access and interact with the simulations displayed on the machine 106.

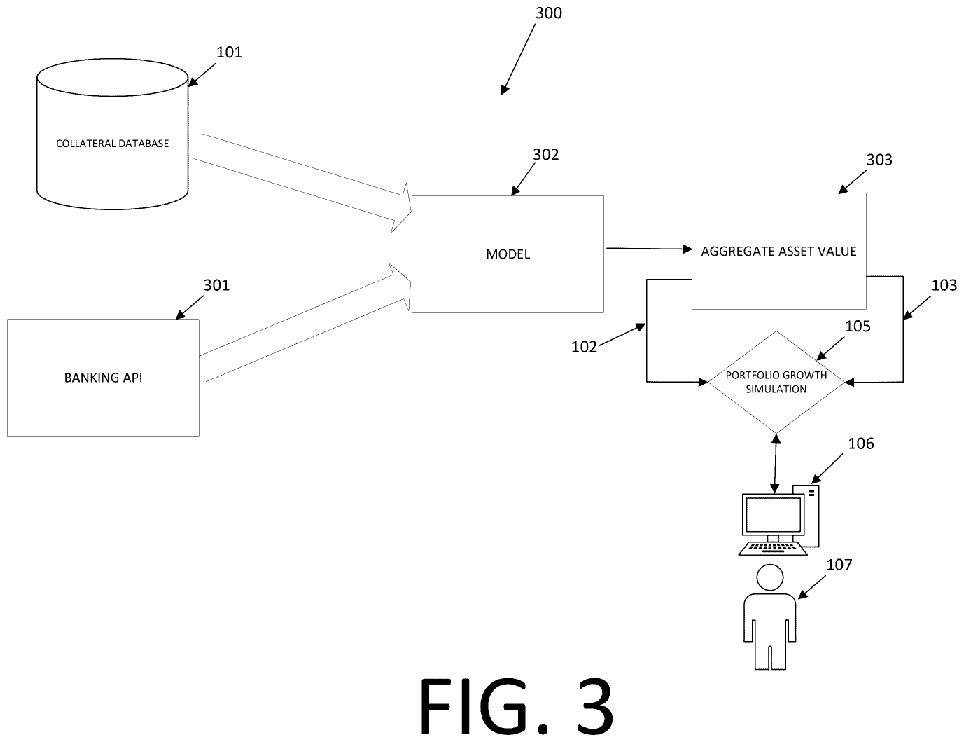

FIG. 3 is a diagram depicting a system for monitoring collateral, in accordance with some embodiments. As shown in FIG. 3, the system 300 includes the collateral database 101. The system 300 further includes a banking Application Programming Interface (API) 301. The banking API allows the system 300 to access and valuate assets from accounts external to the system 300. For example, the banking API may access parameters of assets that are eligible to pledge as collateral (e.g., principal balance, interest rate, projected appreciation, etc.) within an account (e.g., managed investment account) external to the system 300. In some examples, the user 107 may manually enter in the system 300 valuations of external assets.

The system 300 further includes a model 302 coupled to the collateral database 101 and the banking API 301. The model 301 may be, for example, an artificial intelligence (AI) model that is trained to assess parameters of various financial assets and valuate them accordingly.

Furthermore, the model may be implemented on a virtual or physical computer within the system 300. The model 302 aggregates the assets present in one or more portfolios within the collateral database 101 and the assets identified by the banking API (e.g., assets present within an external account of the same user 107 having access to the portfolio within the collateral database 101). Based on data from the collateral database 101 and the banking API 301, the model 302 generates an aggregate asset value 303. The aggregate asset value 303 represents a total valuation of assets identified by the model 302. Based on the aggregate asset value 303, the system 300 can generate the first portfolio growth scenario 102 and the second portfolio growth scenario 103. The system can then generate the portfolio growth simulation 105 based on the first portfolio growth scenario 102 and the second portfolio growth scenario 103 and display it on the machine 106.

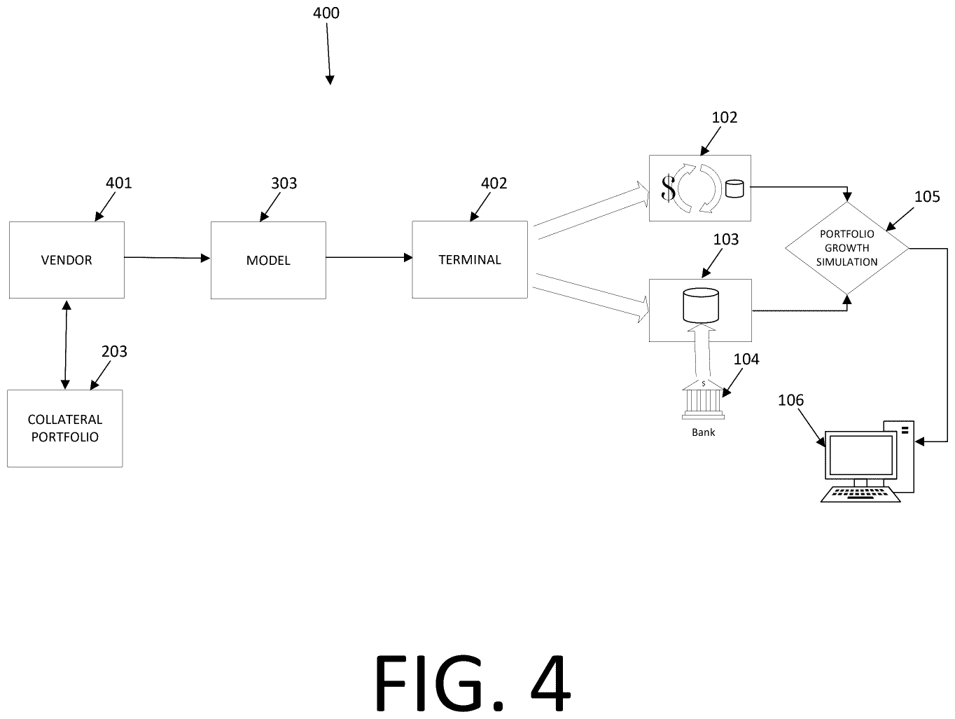

FIG. 4 is a diagram depicting a system for monitoring collateral, in accordance with some embodiments. The system 400 includes a vendor 401. The vendor 401 may be engaged by a financial institution. The collateral portfolio 203 is accessible by the vendor 401. The vendor may monitor assets (e.g., collateral) within the portfolio based on product codes or other parameters. The vendor 401 can determine one or more parameters of the collateral portfolio 203, such as whether assets within the collateral portfolio 101 were purchased under margin and the margin rates of those assets.

The parameters of the collateral portfolio 203 are received by a model 303. The model 303 may be the same model 303 depicted in FIG. 3 or may be different. The model 303 processes the data received from the vendor and determines characteristics (e.g., lending margins) of a prospective loan secured with the assets in the collateral portfolio 203 as collateral. The model 303 may further determine information that can be utilized by a terminal 402. Information from the model 303 is received at the terminal 402. The terminal 402 may determine forward growth rates of the collateral portfolio 203 based on differing investment options. For example, the terminal 402 can generate the first portfolio growth scenario 102 and the second portfolio growth scenario 103.

Based on the first portfolio growth scenario 102 and the second portfolio growth scenario 103, the system 400 generates the portfolio growth simulation 105. As described above, the portfolio growth simulation 105 may include data from both the first portfolio growth scenario 102 and the second portfolio growth scenario 103. In some examples, the portfolio growth simulation 105 is a combination of the first portfolio growth scenario 102 and the second portfolio growth scenario 103 (e.g., first and second portfolio growth scenarios 102, 103 superimposed on each other or displayed adjacent to each other). Additional growth scenarios may be generated based on various investment options. The portfolio growth simulation 105 is received at and displayed on the machine 106.

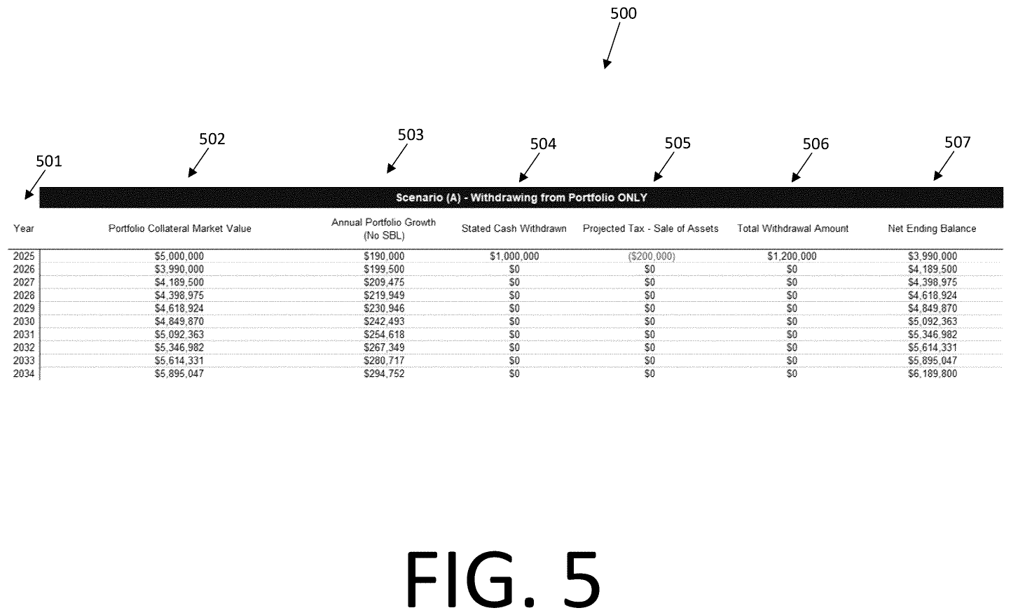

FIG. 5 is a diagram depicting a depleted collateral simulation, in accordance with some embodiments. As illustrated in the detailed example discussed further below, the depleted collateral simulation 500 may be, for example, the first portfolio growth scenario 102 and may represent a hypothetical scenario in which a user depletes a predetermined amount of their portfolio (e.g., to fund an operation). In the example shown in FIG. 5, the depleted collateral simulation 500 includes a first column 501 depicting one or more predefined time intervals. In the example shown in FIG. 5, the predefined time interval is one year and begins at 2025. The depleted collateral simulation 500 includes a portfolio collateral market value indication 502 indicating a collateral market valuation for each of the predefined time intervals.

The depleted collateral simulation 500 further includes a portfolio growth indication 503 indicating a projected (e.g., expected) growth of the collateral portfolio 203 at each of the predefined time intervals. The projected growth represented in the portfolio growth indication 503 may be a growth rate that is based on assets contained within the portfolio and may be based on particular parameters associated with those assets (e.g., financial derivatives, fixed income interest, stock dividends, etc.). In the example shown in FIG. 5, the projected growth rate is 5%. The depleted collateral simulation 500 further includes a cash withdrawn component 504 indicating an amount of collateral depleted, if any, at each of the predefined time intervals. The depleted collateral simulation 500 further includes a projected tax indication 505 specifying a projected tax at each of the predefined time intervals. The depleted collateral simulation 500 further includes a withdrawal amount indication 506 specifying a total amount withdrawn from the portfolio (e.g., including the depletion of collateral and the projected tax for the time interval). The depleted collateral simulation 500 further includes a net ending balance indication 507 specifying a total value of the portfolio at the end of each corresponding time interval.

In the example shown in FIG. 5, a user has a collateral portfolio with a valuation of $5,000,000 at the beginning of the first predefined time interval (i.e., 2025), as shown in the portfolio collateral market value indication 502. The cash withdrawn from the collateral portfolio is $1,000,000 in the first time interval and $0 in subsequent intervals, as indicated in the cash withdrawn component 504. The projected tax on the account is $200,000, as indicated in the projected tax indication 505. The projected tax may be based on, for example, an assumed tax rate (e.g., 20%) applied to the capital acquired through the depletion of collateral. As shown in the total withdrawal amount indication 506, $1,200,000 in total is withdrawn from the portfolio, which includes both the total cash withdrawn 504 from the portfolio as well as the projected tax 505.

The net ending balance indication 507 for the first time interval in the example shown in FIG. 5 is $3,990,000 and represents the amount remaining in the portfolio after subtracting the total withdrawal amount 506 from the portfolio collateral market value 502 at the beginning of the time interval and adding the growth projected by the portfolio growth indication 503. As shown in FIG. 5, the portfolio collateral market value 502 of each time interval is determined to be the net ending balance 507 of the preceding time interval. In the depleted collateral simulation 500 depicted in FIG. 5, the portfolio continually increases in value after the first time interval, when collateral is not being depleted and tax is therefore not applied. In the example shown in FIG. 5, the net ending balance at the last depicted time interval is $6,189,800.

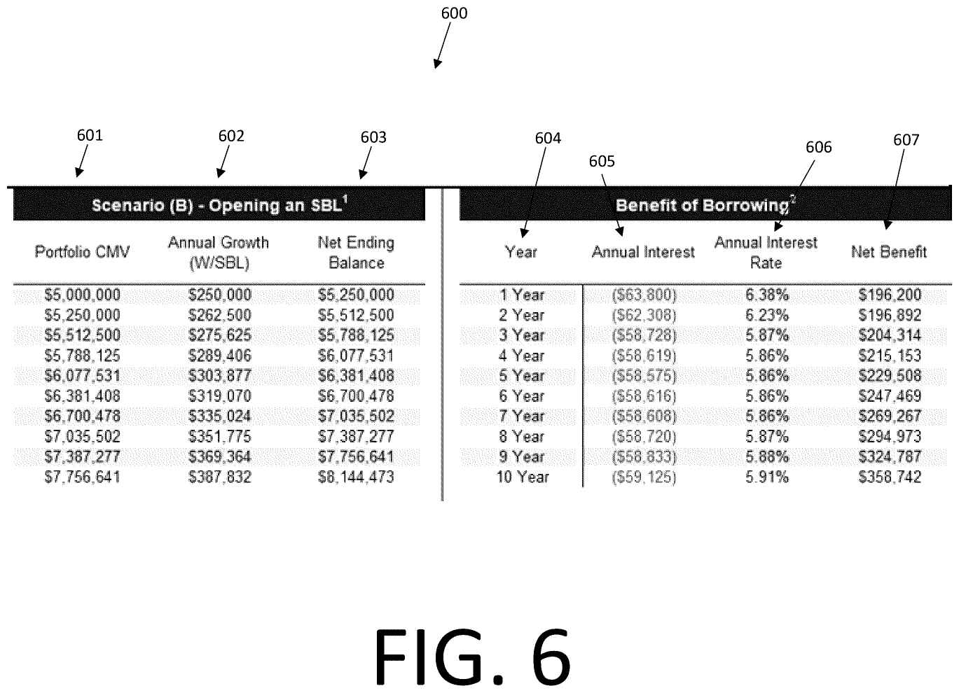

FIG. 6 is a diagram depicting a secured loan simulation, in accordance with some embodiments. The secured loan simulation 600 may be, for example, the second portfolio growth scenario 103 described with respect to preceding figures. Calculations within the secured loan simulation 600 are based on an assumption that the user acquires a loan. The principal loan amount may be in an amount approximately the same or the same as the value of collateral depleted in the depleted collateral simulation 500 depicted in FIG. 5 (e.g., $1,000,000). Furthermore, the loan may be secured by all or a part of the assets within the collateral portfolio 203. In the example shown in FIG. 6, the secured loan simulation 600 includes a portfolio collateral market value 601 specifying a market value of the collateral portfolio 203 at the beginning of each predefined time interval. The time intervals of the secured loan simulation 600 may be the same time intervals utilized in the depleted collateral simulation 500.

The secured loan simulation 600 further includes a portfolio growth indication 602. The portfolio growth indication 602 specifies an amount of growth (i.e., interest) the collateral portfolio 203 experiences during each time interval due to returns on the underlying assets of the collateral portfolio 203. The growth of the portfolio may be based on the same projected growth rate used in the depleted collateral simulation 500. In the example shown in FIG. 6, the projected growth rate is 5%. The secured loan simulation 600 further includes a net ending balance indication 603 specifying the ending balance of the collateral portfolio 203 at the end of each predefined time interval. Returns on the collateral portfolio 203 are compounded such that the net ending balance 603 at each time interval is based on the growth of the total collateral portfolio 203, including returns of preceding time intervals.

The secured loan simulation 600 further includes a time interval indication 604 specifying the time intervals for which other parameters of the secured loan simulation 600 are determined. As described above, these time intervals 604 may be the same time intervals used in the depleted collateral simulation 500. The secured loan simulation 600 further includes an annual interest indication 605. The annual interest indication 605 specifies the amount of interest that the user 107 must pay each time interval 604 due to the accumulation of interest on their secured loan.

The secured loan simulation 600 further includes an interest rate indication 606 specifying an interest rate applied to the secured loan at each of the time intervals 604. The interest rate of the secured loan may be lower than an interest rate of an unsecured loan, or of a loan that is secured with a lesser value of collateral. The interest rates reflected in the interest rate indication 606 may be based on a Secured Overnight Financing Rate (SOFR) that is determined at predetermined time intervals (e.g., quarterly). Furthermore, the interest rates may be based on various parameters of the collateral within the collateral portfolio 203, such as volatility, expected growth rates, and liquidity of the collateral. The interest rates may be calculated by the secured lending benefit analysis tool 100 (FIG. 1), the model 302 (FIG. 3), the terminal 402 (FIG. 4), or may be provided to a financial institution by a third party (e.g., the vendor 401 (FIG. 4)).

The secured loan simulation 600 further includes a net benefit indication 607. The net benefit indication 607 indicates a difference in value (e.g., net worth) of the user 107 between the depleted collateral simulation 500 and the secured loan simulation 600. In the example shown in FIG. 6, the net benefit indication 607 is determined by first determining a portion of a user's worth that is attributable to the secured loan simulation 600 for a particular time interval. That determination is made by subtracting the interest due 605 for the time interval from the net ending balance 603 of the same time interval. For example, in the first time interval (e.g., the first year), the net worth attributable to the secured loan simulation 600 is calculated by subtracting the interest due ($63,800) from the net ending balance of the first time interval ($5,250,000), resulting in $5,186,200.

To determine a net worth of the user attributable to the depleted collateral simulation 500, the net ending balance 507 (FIG. 5) of the time interval is added to the cash withdrawn 504 (i.e., collateral depleted) during that time interval. This determination accounts for the total value of the collateral portfolio 203 at the end of a specified time interval, as well as capital derived from the depleted collateral (which may be in an account other than the collateral portfolio 203 in some examples). In the example shown in FIGS. 5 and 6, the value attributable to the depleted collateral simulation 500 in the first time interval is determined by adding the cash withdrawn in the first time interval ($1,000,000) to the net ending balance of the first time interval ($3,990,000), resulting in $4,990,000.

To determine the net benefit indication 607, the net value attributable to the depleted collateral simulation 500 is subtracted from the net value based on the secured loan simulation 600. For the first time interval, this calculation results in a difference of $196,200 between the two scenarios 500, 600. Thus, a user obtaining a secured loan of a predetermined amount (e.g., $1,000,000) would have a net benefit $196,200 greater than if that user had depleted collateral of the same predetermined amount. Similar determinations are made for the net benefit indication 607 of subsequent time intervals.

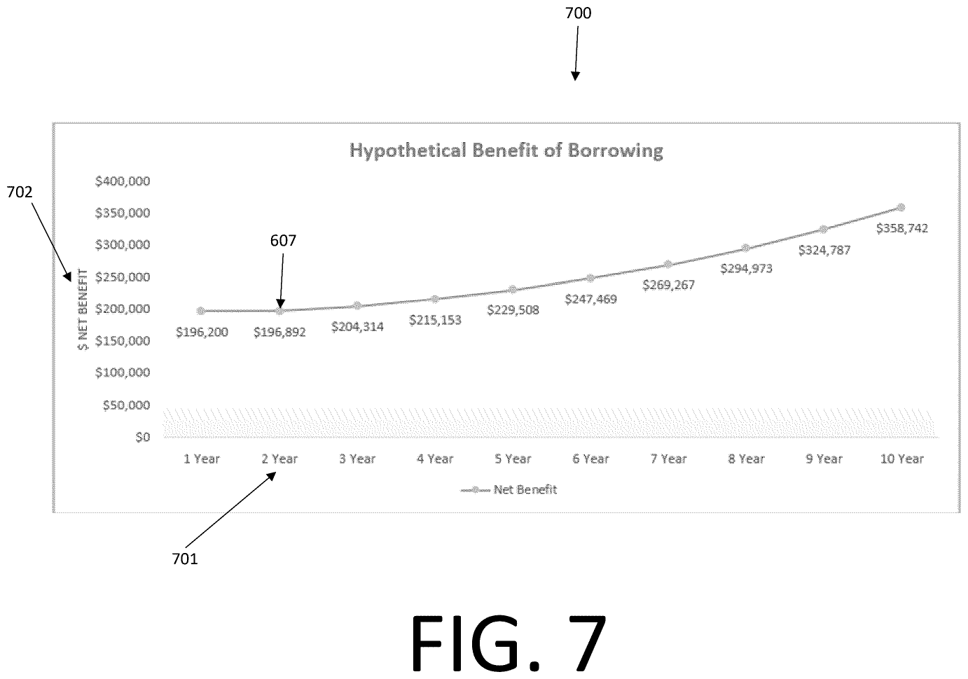

FIG. 7 is a diagram depicting a benefit of borrowing simulation, in accordance with some embodiments. The benefit of borrowing simulation 700 includes a first axis 701 depicting particular time intervals for which parameters in the depleted collateral simulation 500 and the secured loan simulation 600 are determined. A second axis 702 depicts values of the net benefit indication 607. The net benefit indication 607 is plotted in the benefit of borrowing simulation 700 for each predefined time interval. As shown in FIG. 7, the net benefit indication 607 may increase with successive time intervals.

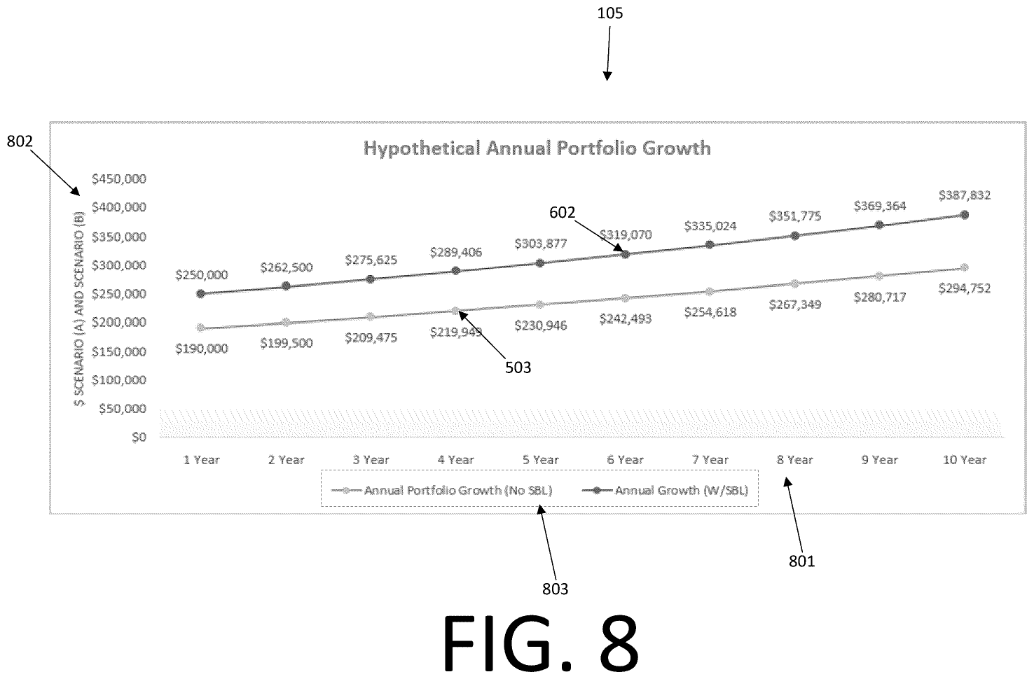

FIG. 8 is a diagram depicting a portfolio growth simulation, in accordance with some embodiments. The portfolio growth simulation 105 includes a first axis 801 depicting particular time intervals for which parameters in the depleted collateral simulation 500 and the secured loan simulation 600 are determined. A second axis 802 depicts growth amounts of the portfolio growth indication 503 shown in FIG. 5 (i.e., based on the depleted collateral simulation 500) and of the portfolio growth indication 602 shown in FIG. 6 (i.e., based on the secured loan simulation 600). The portfolio growth indications 503, 602 are plotted in the portfolio growth simulation 105. A legend 803 specifies which curve corresponds to each portfolio growth indication 503, 602. In the example shown in FIG. 8, the portfolio growth indication 602 based on the secured loan simulation 600 is greater than the portfolio growth indication 503 based on the depleted collateral simulation 500. Moreover, a difference between the portfolio growth simulations 503, 602 increases with each subsequent time interval.

In some examples, the portfolio growth simulation 105 indicates whether the first portfolio growth scenario 102 or the second portfolio growth scenario 103 is more advantageous to the user 107 (e.g., the preferred growth scenario 110). As described above, this determination may be based on the individual objectives of the user 107 or may be based on maximizing a worth of the user 107. In the example depicted in FIG. 8, the second portfolio growth simulation 103 (i.e., based on the user obtaining a secured loan) is advantageous to a user's 107 goal of maximizing the user's 107 portfolio value and consequently net worth.

In some instances, users 107 or entities execute funding transactions frequently or at predetermined time intervals (e.g., daily, monthly, quarterly). In such examples, there may be insufficient time for a user 107 or a financial advisor to evaluate each of the growth scenarios depicted in the portfolio growth simulation 105 (which may vary depending on the objectives of the individual user 107) and to subsequently execute a financial transaction based on the growth scenario most advantageous to the user 107. In an example, the portfolio growth scenario 102, 103 that is determined to be most advantageous to the user 107 based on the portfolio growth simulation 105 is automatically executed. This automatic execution can obviate some of the concerns associated with human involvement. In some examples, the automatic execution occurs on a predetermined basis (e.g., daily, monthly, quarterly).

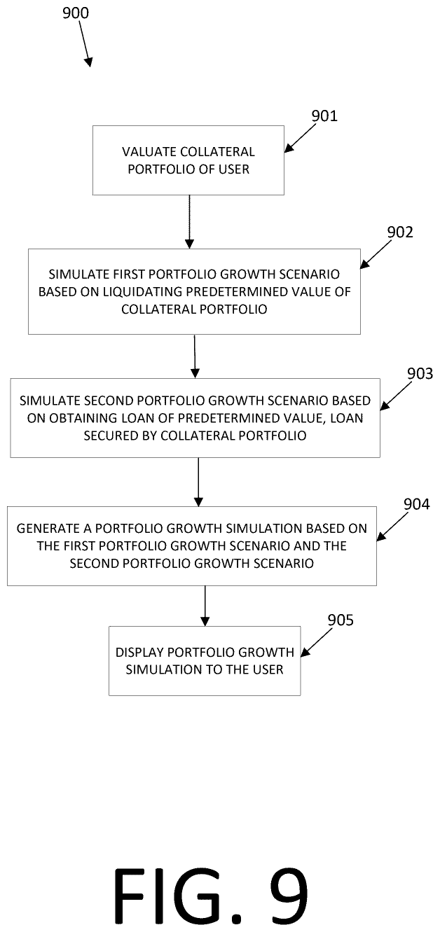

FIG. 9 is a diagram depicting a method of determining a preferred investment strategy, in accordance with some embodiments. The method 900 includes a first step 901 of valuating a collateral portfolio of a user. At 902, a first portfolio growth scenario is simulated based on liquidating a predetermined value of the collateral portfolio. At 903, a second portfolio growth scenario is simulated based on obtaining a loan of a predetermined value. The loan is secured by the collateral portfolio. At 904, a portfolio growth simulation is generated based on the first portfolio growth scenario and the second portfolio growth scenario. At 905, the portfolio growth simulation is displayed to the user.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein and may be provided in any suitable language such as C, C++, JAVA, for example, or any other suitable programming language. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents.

It is claimed:

1. A secured lending benefit analysis tool comprising:
one or more collateral databases including a valuation of a collateral portfolio of a user;
a processor coupled to the one or more collateral databases, the processor configured to:
simulate a first portfolio growth scenario based on liquidating a predetermined value of the collateral portfolio;
simulate a second portfolio growth scenario based on obtaining a loan of the predetermined value, the loan secured by collateral of the collateral portfolio;
generate a portfolio growth simulation based on the first portfolio growth scenario and the second portfolio growth scenario; and
display the portfolio growth simulation to the user.

2. The secured lending benefit analysis tool of claim 1, wherein the steps of the processor are performed in response to a user input.

3. The secured lending benefit analysis tool of claim 2, wherein the user input is an indication that the user wishes to liquidate the predetermined value of the collateral portfolio.

4. The secured lending benefit analysis tool of claim 1, the processor further configured to display a preferred growth scenario to the user.

5. The secured lending benefit analysis tool of claim 1, wherein the first portfolio growth scenario and the second portfolio growth scenario are simulated over a predetermined time period.

6. The secured lending benefit analysis tool of claim 5, wherein the processor is further configured to simulate the first portfolio growth scenario and the second portfolio growth scenario at a plurality of time intervals within the predetermined time period.

7. The secured lending benefit analysis tool of claim 1, wherein simulating the first portfolio growth scenario includes projecting a tax on the predetermined value of the collateral portfolio.

8. The secured lending benefit analysis tool of claim 7, wherein simulating the first portfolio growth scenario further includes calculating a first future value based on a remaining value of the collateral portfolio and an investment rate of return.

9. The secured lending benefit analysis tool of claim 8, wherein simulating the second portfolio growth scenario further includes calculating a second future value based on the predetermined value of the collateral portfolio and the investment rate of return.

10. A computer network comprising:
one or more collateral databases including a plurality of collateral portfolios for a plurality of users;
a secured lending benefit analysis tool having access to the one or more collateral databases, the secured lending benefit analysis tool configured to:
receive a user input from a machine being accessed by one of the plurality of users;
based on the user input, simulate a first portfolio growth scenario based on liquidating a predetermined value of one of the collateral portfolios;
based on the user input, simulate a second portfolio growth scenario based on obtaining a loan of the predetermined value, the loan secured by collateral of the collateral portfolio;
generate a portfolio growth simulation based on the first portfolio growth scenario and the second portfolio growth scenario; and
display, on the machine, the portfolio growth simulation.

11. The computer network of claim 10, wherein the user input is an indication that the user wishes to liquidate the predetermined value of the collateral portfolio.

12. The computer network of claim 10, the secured lending benefit analysis tool further configured to display a preferred growth scenario to the user.

13. The computer network of claim 10, wherein the first portfolio growth scenario and the second portfolio growth scenario are simulated over a predetermined time period.

14. The computer network of claim 13, wherein the secured lending benefit analysis tool is further configured to simulate the first portfolio growth scenario and the second portfolio growth scenario at a plurality of time intervals within the predetermined time period.

15. The computer network of claim 10, wherein simulating the first portfolio growth scenario includes projecting a tax on the predetermined value of the collateral portfolio.

16. The computer network of claim 15, wherein simulating the first portfolio growth scenario further includes calculating a first future value based on a remaining value of the collateral portfolio and an investment rate of return.

17. The computer network of claim 16, wherein simulating the second portfolio growth scenario further includes calculating a second future value based on the predetermined value of the collateral portfolio and the investment rate of return.

18. A method of determining a portfolio growth simulation comprising:
valuating a collateral portfolio of a user;
simulating a first portfolio growth scenario based on liquidating a predetermined value of the collateral portfolio;
simulating a second portfolio growth scenario based on obtaining a loan of the predetermined value, the loan secured by collateral of the collateral portfolio;
generating a portfolio growth simulation based on the first portfolio growth scenario and the second portfolio growth scenario; and
displaying the portfolio growth simulation to the user.

19. The method of claim 18, further comprising receiving a user input from the user, wherein the simulation of the first portfolio growth scenario and the second portfolio growth scenario are based on the user input.

20. The method of claim 18, wherein the first portfolio growth scenario and the second portfolio growth scenario are simulated over a predetermined time period.
